(19) United States
(12) Patent Application Publication
(10) Pub. No.: US 2009/0200706 A1
(43) Pub. Date: Aug. 13, 2009

(54) Method and Device for Moulding Elastomeric Objects

(75) Inventors: Christophe Bessac, Cebazat (FR); Frederic Pialot, Moissat (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/297,122

(22) PCT Filed: Apr. 5, 2007
(86) PCT No.: PCT/EP2007/003102

§ 371 Date: Oct. 14, 2008

(30) Foreign Application Priority Data
Apr. 11, 2006 (FR) 0603476

(51) Int. Cl. B29C 45/14

(52) U.S. Cl. 264/279; 425/144; 264/328.1

(57) ABSTRACT

A process and a device for moulding elastomeric articles. The device comprises: a mould (2) having a mould cavity (3); injection means (4), for injecting an uncured elastomeric material (1) into the mould cavity; a shut-off valve (9), for shutting off the mould cavity, which can move between an open position and a closed position; and control means (10), for controlling the temperature of the elastomeric compound contained in the mould cavity.

The present invention relates to the manufacture of elastomeric articles. It relates in particular to the moulding of vibration-absorbing parts, such as articulations or stops used for ground connections of motor vehicles.

The manufacture of these articles is relatively complex, lengthy and expensive. Over the course of the moulding operation, the uncured elastomeric material must be introduced into a mould cavity and remain there for a sufficient time under given temperature and pressure conditions so as to be vulcanized therein. The vulcanization time is often several minutes, during which the mould is immobilized in a moulding machine. To optimize the production of a moulding machine, in general several articles are moulded simultaneously in a mould comprising a corresponding number of mould cavities or “impressions”, for example around 10 or even more cavities. The various cavities of the mould are then connected to the outside and to one another via a set of feed channels. Once the articles have been vulcanized and extracted from the mould, they have to be separated from the material moulded by the set of feed channels. This moulded part, of no use in the finished article, is often called a “sprue tree” owing to its shape. This work of separating them is difficult to carry out and often leaves undesirable traces on the finished articles. The mass of the sprue tree represents a substantial portion of the injected material, this portion generally increasing with the number of cavities in the mould, that is to say with the number of articles moulded simultaneously. In certain cases, the sprue tree may represent up to 50% of the amount of material injected. Increasing the number of cavities also makes it complicated to fill each mould cavity properly and to optimize the temperature control of the elastomeric material in each cavity. Thus, despite all efforts made, the dispersion of the mechanical and physical characteristics of the moulded articles may be unacceptable to the point that a final inspection must be carried out and that a not insignificant portion of the production must sometimes be scrapped following this inspection. It will be appreciated that all these difficulties and losses of material contribute substantially to the industrial production cost.

In addition, to feed such moulding machines with uncured elastomeric material, powerful injection means must be used that are capable of rapidly injecting, under high pressure, a large amount of uncured elastomeric material. However, these expensive injection means are greatly underemployed since the injection lasts only a few seconds, whereas several minutes elapse between each injection.

One objective of the invention is therefore to alleviate some of the aforementioned drawbacks, so as to reduce the industrial production cost of such articles.

This objective is achieved by a process for moulding elastomeric articles, which comprises in succession the steps consisting in:

injecting a controlled amount of an uncured elastomeric compound directly into a mould cavity of a mould;

closing the mould cavity of the mould;

subjecting the elastomeric compound contained in the mould cavity to a controlled temperature;

opening the mould; and

extracting the moulded elastomeric article from the mould.

Preferably, a mould comprising a single mould cavity intended to mould a single article is used.

Preferably, the uncured elastomeric compound is injected into the mould cavity with the aid of injection means that can move in relation to the mould.

Preferably, the opening of the mould cavity is controlled by the relative movement of the injection means in relation to the mould.

Preferably, the closing of the mould cavity is also controlled by the relative movement of the injection means in relation to the mould.

Preferably, the amount of compound injected into the mould cavity is controlled according to the volume of compound delivered by the injection means.

Preferably, the compound is injected into the mould cavity by means of an end nozzle orifice of small cross section so that the temperature of the injected compound is above the temperature of the compound before it passes through said nozzle orifice.

Preferably, the mould is supplied with thermal energy.

Preferably, the mould cavity is partly defined by an insert placed in the mould before the uncured compound is injected, the insert being incorporated into the moulded article.

Preferably, different articles are moulded in succession.

According to a variant of the invention, to form a given article, at least two different elastomeric compounds are injected in succession into two different mould cavities. A first cavity is used to mould a first layer and then an overmoulding operation is carried out within a larger cavity in which the product from the first moulding is placed.

The invention furthermore relates to a device for moulding elastomeric articles, said device comprising:

a mould having a mould cavity;

injection means, for injecting an uncured elastomeric material into the mould cavity;

a shut-off valve, for shutting off the mould cavity, which can move between an open position and a closed position; and

control means, for controlling the temperature of the elastomeric compound contained in the mould cavity.

Preferably, the shut-off valve is configured so as to constitute, in the closed position, a substantially continuous portion of the surface of the mould cavity.

Preferably, the injection means comprise a nozzle, the nozzle being able to move in relation to the mould between an injecting position and a retracted position, the nozzle being configured so as to cooperate with the shut-off valve in order to allow the uncured compound to be injected directly into the mould cavity when the shut-off valve is in the open position and the nozzle is in the injecting position.

Preferably, a spring tends to keep the shut-off valve in the closed position.

Preferably, the shut-off valve and the nozzle are configured so that the movement of the nozzle from its retracted position to its injecting position acts against the spring so as to move the shut-off valve into its open position.

Preferably, the nozzle has an outer cylindrical surface that cooperates with an inner cylindrical surface of corresponding section of the shut-off valve.

Preferably, the nozzle opens into the cavity in a direction approximately perpendicular to a generatrix of the outer surface of the nozzle.

Preferably, the nozzle opens through an end nozzle orifice of substantially small cross section compared with the cross section of the nozzle.

Preferably, the device comprises several moulds, a shut-off valve being associated with each mould, the device further including means for circulating the moulds, enabling each mould to be moved in succession between an injecting station, a curing station and a demoulding station.

Other objectives and advantages of the invention will become more clearly apparent in the following description of the figures appended to the present application, in which:

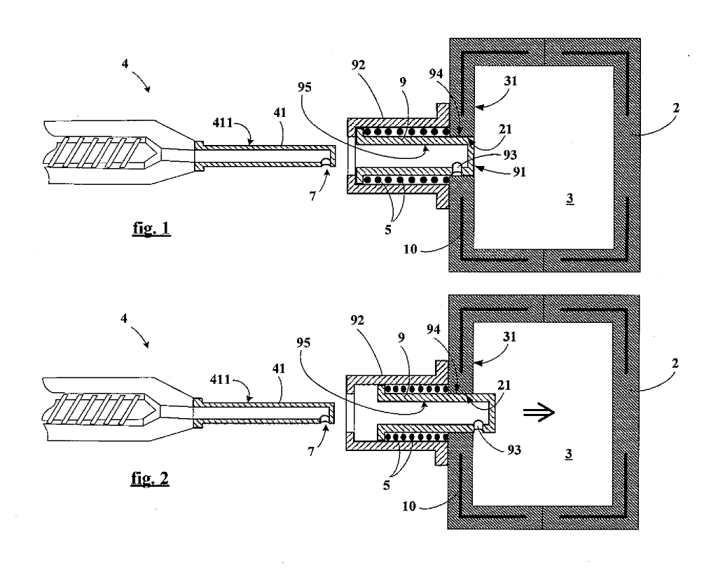

FIGS. 1 to 6 show schematically in cross section the device of the invention at various stages in the moulding process;

FIG. 7 shows, in the same view, one particular case in which an insert is positioned in the mould before the moulding;

FIG. 8 shows in perspective and in cross section an example of the moulding of an elastomeric part; and

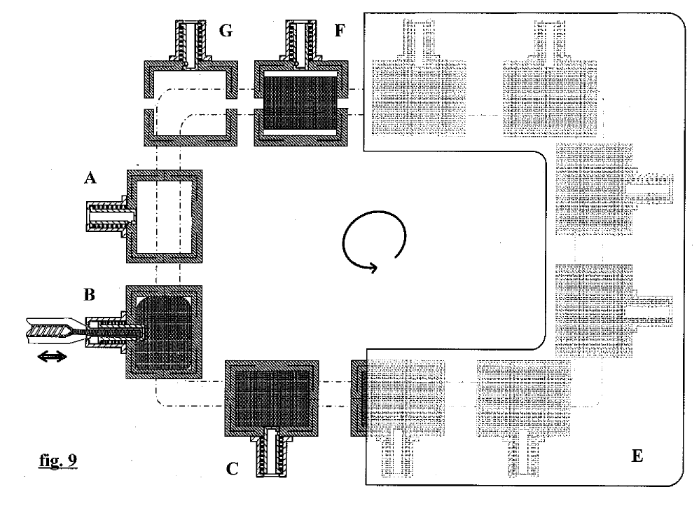

FIG. 9 shows an example of an organization in the form of a carousel of the process according to the invention.

The various figures show many identical or similar elements, so that their description is not systematically repeated for each figure.

FIGS. 1 to 6 show schematically a preferred embodiment of the moulding device and its use according to the process of the invention.

The device comprises at least one mould 2 which defines, when it is closed (FIGS. 1 to 5), a mould cavity 3. Access to the cavity from outside the mould is controlled by a shut-off valve 9. The shut-off valve 9 can move between a closed position (see FIG. 1) and an open position (see FIG. 2). To switch from the closed position to the open position, the shut-off valve advances into the moulding cavity. When the shut-off valve is in the closed position, it preferably constitutes a substantially continuous portion 91 of the surface 31 forming the boundary of the mould cavity 3.

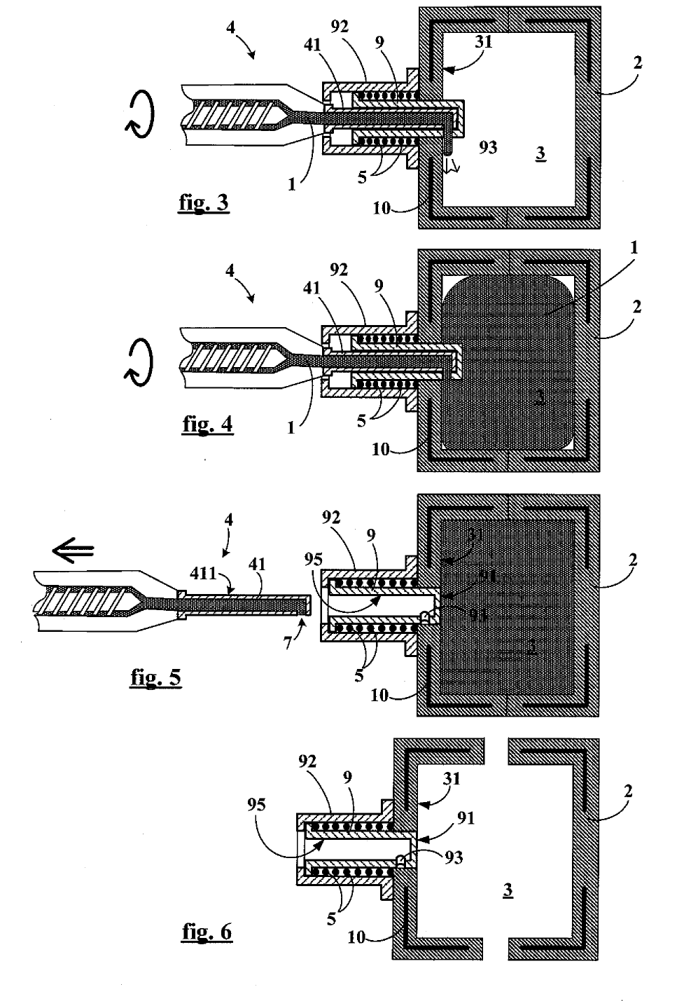

Injection means 4 allow an uncured elastomeric material 1 to be injected into the mould cavity (see FIGS. 3 and 4). Preferably, said injection means comprise an elastomer pump of the positive-displacement type, that is to say of the type that is capable of delivering a relatively precise amount of material. The injection means 4 can move in relation to the mould 3 (or vice versa) and comprise a nozzle 41 that has the main function of cooperating with the shut-off valve in order to allow the injection means to be connected to the mould cavity and to be disconnected therefrom. Preferably, the nozzle also has the function of positively controlling the opening of the shut-off valve over the course of the movement bringing the injection means and the mould together (for convenience we will hereafter call this relative movement of the injection means and the mould, during which the connection is made, “docking”. The figures show a preferred embodiment of this control function in which the shut-off valve 9 is subjected to the action of a spring 5 which tends to keep said valve in the closed position (i.e. in abutment in its casing 92), the nozzle, during docking, pressing the shut-off valve into its open position against the spring.

Preferably, the shut-off valve has an outer cylindrical surface 94 of cross section corresponding to the cross section of a cylindrical passage 21 in the wall of the mould. Thus, the shut-off valve is guided into said passage practically without any clearance (and therefore without any loss of moulding material). Preferably, these two cross sections are round.

The shut-off valve has a lateral opening 93 which opens into the cavity only when the shut-off valve is pushed into the mould (i.e. when the shut-off valve is in the open position, as in FIG. 2).

Preferably, the nozzle 41 has an outer cylindrical shape of round cross section designed to slide inside the shut-off valve 9. The inner cross section of the shut-off valve is also preferably cylindrical, of round cross section, so that their surfaces (411 and 94 respectively) cooperate so as to guide the docking with minimal clearance. A slight tapering between the nozzle and the shut-off valve may further facilitate the docking.

In the example shown in the figures, it is the end of the nozzle 41 that will press on the shut-off valve in order to push it into its open position (see in particular FIG. 3). Of course, other arrangements are conceivable.

In FIGS. 1 and 2, the nozzle 41 is shown in the retracted position.

Preferably, the nozzle 41 opens via an end nozzle orifice 7 having a small cross section (compared with the average inner cross section of the nozzle) so as to increase the shear and therefore the temperature of the injected material at the moment when it penetrates the mould cavity. For example, in the case of an elastomeric material in foam form, it may be advantageous for the ratio of the cross section of the nozzle orifice to that of the nozzle to be less than 1:10, or even 1:20. The restriction created by the nozzle orifice 7 may, as an alternative, be created by a lateral opening 93 of small cross section in the shut-off valve.

Means 10 for controlling the temperature of the mould cavity, for example electrical resistors placed in the wall of the mould 2, are used to vary the temperature of the elastomeric material during moulding.

A preferred embodiment of the process for moulding elastomeric articles according to the invention will now be described with reference to FIGS. 3 to 6.

Since the process according to the invention is intended to be repeated substantially continuously, we will consider in this description that the step illustrated in FIG. 3 is the first step of the process. During this step, since the mould is closed, the injection means 4 are brought into communication with the mould cavity 3, the shut-off valve 9 being in the open position. The nozzle 41 is therefore in the injecting position. A controlled amount of elastomer is then injected into the cavity (see FIGS. 3 and 4). The elastomer is delivered by the nozzle directly into the cavity, i.e. into the volume of the final article.

Preferably, the amount injected is controlled by controlling the volume injected, for example with the aid of an elastomer pump. Applications EP 400 496 and EP 690 229 describe examples of elastomer pumps for precisely controlling the amount of compound injected. The amount injected may also be controlled by measuring the pressure exerted in the cavity on the shut-off valve or in the nozzle.

When the desired amount of elastomer has been introduced into the cavity, the injection is interrupted, the shut-off valve adopts its closed position (see FIG. 5) and the injection means are disconnected from the cavity. The nozzle 41 is again in its retracted position. The temperature of the elastomer contained in the cavity is then controlled so as to carry out the vulcanization thereof. This temperature control may consist in supplying heat by any known means (for example by induction or with the aid of electrical resistors 10 placed in the walls of the mould) or by the mould simply being in an oven if the injection temperature is high enough. The temperature of the compound can therefore be controlled directly or indirectly.

During this vulcanization step, the mould 2 is therefore independent of the injection means 4. Thus, the elastomeric material contained in the nozzle between two injections is not subjected to the in-mould vulcanization cycle—it remains in the “cool” zone. It will also be understood that the injection means may serve for feeding one or more other moulds while the elastomer is being vulcanized in the first mould.

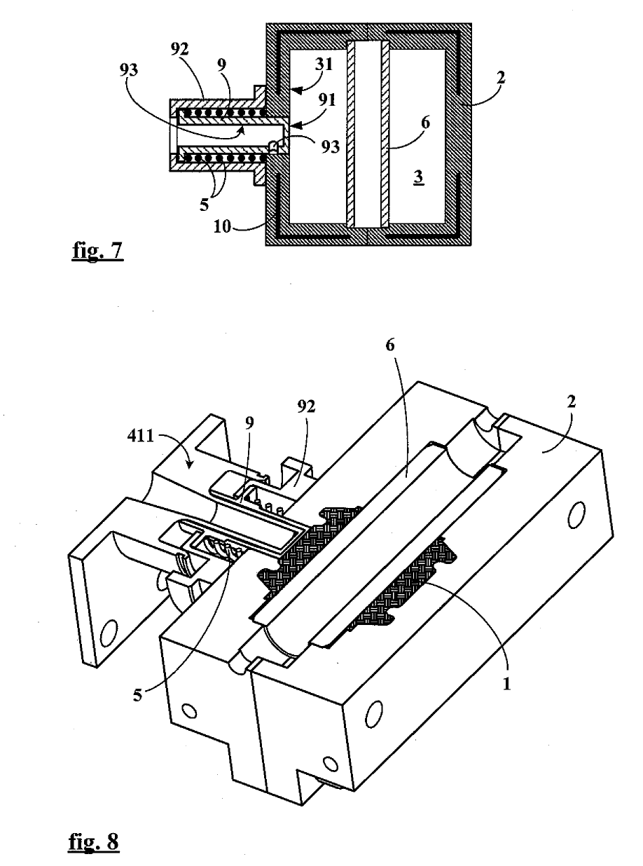

Finally, when the vulcanization has progressed sufficiently, the mould is opened and the moulded article extracted from the mould (see FIG. 6). The process can then be repeated for moulding a new article.

As may be seen in these drawings showing the principle of the process, the shut-off valve is preferably configured so as to allow direct communication between the injection means and the mould cavity. The mould does not have an injection channel and therefore no injection sprue or sprue tree is created that would have to be removed subsequently. The injection therefore takes place directly into the mould cavity 3 (i.e. within the volume of the article), without following an intermediate duct linked to the mould and therefore linked to the “hot” zone.

One advantageous feature of the process of the invention is that the vulcanization takes place while the cavity is hermetically sealed. A substantial pressure can therefore be maintained within the elastomer. This pressure may have been provided by the injection means, but also generated after the injection by the rise in temperature of the material and/or by the specific effect of its crosslinking. It is thus possible to obtain high-quality mouldings (free of filling defects, great homogeneity of the mechanical properties of the moulded material, low variation from one article to another).

FIG. 7 shows schematically the case in which the article includes an insert (here a connecting reinforcement 6), this insert being deposited in the mould before the elastomeric material is injected. The insert may, as here, partly define the mould cavity, but it may also be embedded in the moulding.

FIG. 8 shows, in perspective and in axial cross section, an exemplary embodiment of a mould according to the invention intended for the manufacture of telescopic shock-absorber eye type rubber mount. The figure clearly shows the central bushing 6, the elastomeric sleeve filling the mould cavity 3, the shut-off valve 9 in the closed position, with its return spring 5, and the nozzle 41.

FIG. 9 shows schematically a preferred embodiment of the device of the invention in which it comprises several moulds that can move between several stations. Circulation means (shown here in the form of rails) allow the many moulds to move from one station to another.

At the station A, a closed, empty mould is ready to receive the injection of elastomeric material. If necessary, one or more inserts may be placed in the mould at this stage.

When the mould reaches the injecting station B, the injection means 4 are connected to the mould cavity, the shut-off valve 9 being in the open position. The injection takes place as described above with reference to FIG. 4.

When the injection has been completed, i.e. when the mould cavity contains the desired amount of elastomeric material, the injection means are disconnected from the mould and the shut-off valve resumes its closed position. The mould can then be sent to a heating station C where a controlled amount of heat can be transferred into it so as to allow the material to be vulcanized.

The vulcanization then takes place along the path in an oven E (here in the form of a tunnel) in which the mould retains all or part of its heat and its internal pressure.

Once the article has been vulcanized sufficiently to be able to be demoulded, the mould reaches a demoulding station F where the mould is opened and the article extracted from its cavity.

The empty mould can then be cleaned in the cleaning station G. It can also be shunted to a storage zone and another mould (for example intended to mould another article reference) may replace it on the carousel. Once the mould has reached the station A, another moulding cycle can start.

It will be understood that such an installation makes it possible to optimize the degree of use of the various means by varying the parameters, comprising the number of stations dedicated to each operation, the length of travel in the oven, the amount of thermal energy supplied to the mould, and the speed of movement of the moulds.

For example, if a single injecting station is used and the connection-injection-disconnection cycle lasts 30 seconds, a mould can be filled every 30 seconds and a moulded article obtained every 30 seconds insofar as each of the other stations is capable of following this pace. If the vulcanization of this article requires an oven treatment lasting 5 minutes, it will therefore be necessary to use an oven capable of containing around ten moulds. Likewise, if the heating means have to act for 1 minute, two successive heating stations may be provided, each acting in turn for 30 seconds on the mould.

It will be clearly seen that by reasoning in this way for all the operations (demoulding, cleaning, storage, introduction of inserts, etc.), the use of each element of the device may tend towards 100% of its capabilities.

It may also be seen that the injection means do not necessarily have a high power since they feed only a single cavity.

Furthermore, it may be seen that there is no material loss, no sprue tree to be removed and a potentially smaller dispersion since each article produced undergoes the same operations under very similar conditions.

The process and the device of the invention can be used to mould elastomer articles of any type and any shape. One advantageous application relates to elastomers in foam form (for example rubber foam). The foaming may in fact take place during injection at the end nozzle orifice 7 and allow the cavity to be homogeneously and rapidly filled. The process of the invention is also advantageous for moulding other kinds of elastomer-based materials, for example those reinforced with fibres or blended with resins or containing fillers, so as to give the moulded materials mechanical properties covering an extremely wide range.

It will also be understood that the process of the invention can equally be used for successively moulding, with common means, various articles according to different “recipes” (material injected, amount injected, mould used, temperature of the mould, vulcanization time, etc.) within a given manufacturing campaign.

1. A process for moulding elastomeric articles, which comprises in succession the steps of:
injecting a controlled amount of an uncured elastomeric compound (1) directly into a mould cavity (3) of a mould (2);
closing the mould cavity of the mould;
subjecting the elastomeric compound contained in the mould cavity to a controlled temperature (10);
opening the mould; and
extracting the moulded elastomeric article from the mould.

2. The process according to claim 1, comprising providing a mould having a single mould cavity (3) adapted to mould a single article.

3. The process according to claim 1, wherein the uncured elastomeric compound (1) is injected into the mould cavity (3) with the aid of injection means (4) that can move in relation to the mould (2).

4. The process according to claim 3, wherein the opening of the mould cavity is controlled by the relative movement of the injection means in relation to the mould.

5. The process according to claim 4, wherein the closing of the mould cavity is also controlled by the relative movement of the injection means in relation to the mould.

6. The process according to claim 1, wherein the amount of compound injected into the mould cavity is controlled according to the volume of compound delivered by the injection means.

7. The process according to claim 1, wherein the compound is injected into the mould cavity by means of an end nozzle orifice (7) of small cross section so that the temperature of the injected compound is above the temperature of the compound before it passes through said nozzle orifice.

8. The process according to claim 1, wherein the mould is supplied with thermal energy.

9. The process according to claim 1, wherein the mould cavity is partly defined by an insert placed in the mould before the uncured compound is injected, the insert being incorporated into the moulded article.

10. The process according to claim 1, wherein different articles are moulded in succession.

11. The process according to claim 1, wherein, to form a given article, at least two different elastomeric compounds are injected in succession into two different mould cavities.

12. A device for moulding elastomeric articles, the device comprising;
a mould (2) having a mould cavity (3);
injection means (4), for injecting an uncured elastomeric material (1) into the mould cavity;
a shutoff valve (9), for shutting off the mould cavity, which can move between an open position and a closed position; and
control means (10), for controlling the temperature of the elastomeric compound contained in the mould cavity.

13. The device according to claim 12, wherein the shut-off valve is configured so as to constitute, in the closed position, a substantially continuous portion (91) of the surface of the mould cavity (3).

14. The device according to claim 12, wherein the injection means (4) comprise a nozzle (41), the nozzle being able to move in relation to the mould between an injecting position and a retracted position, the nozzle being configured so as to cooperate with the shut-off valve (9) in order to allow the uncured compound to be injected directly into the mould cavity when the shut-off valve is in the open position and the nozzle is in the injecting position.

15. The device according to claim 14, wherein a spring (5) tends to keep the shut-off valve (9) in the closed position.

16. The device according to claim 15, wherein the shut-off valve and the nozzle are configured so that the movement of the nozzle from its retracted position to its injecting position acts against the spring so as to move the shut-off valve into its open position.

17. The device according to claim 12, wherein the nozzle has an outer cylindrical surface (411) that cooperates with an inner cylindrical surface (94) of corresponding section of the shut-off valve (9).

18. The device according to claim 17, wherein the nozzle opens into the cavity in a direction approximately perpendicular to a generatrix of the outer surface (411) of the nozzle.

19. The device according to claim 13, wherein the nozzle opens through an end nozzle orifice (7) of substantially small cross section compared with the cross section of the nozzle.

20. The device according to claim 12, comprising several moulds, a shut-off valve being associated with each mould, the device further including means for circulating the moulds, enabling each mould to be moved in succession between an injecting station, a curing station and a demoulding station,
